(19) United States
(12) Patent Application Publication
(10) Pub. No.: US 2003/0065680 A1
(43) Pub. Date: Apr. 3, 2003

(54) Data providing system and data providing method

(75) Inventor: Koichi Hatakeyama, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/252,609

(22) Filed: Sep. 24, 2002

(30) Foreign Application Priority Data
Oct. 3, 2001 (JP) 2001-307063

(51) Int. Cl. G06F 7/00

(52) U.S. Cl. 707/104.1

(57) ABSTRACT

A sending unit obtains data designated by a user from a plurality of data stored in a database. Then, the sending unit sends the obtained data through a communication line to a delivery center at which the user is to receive the data. When doing so, the sending unit sees to it that sending of the data designated by the user will be completed by a date designated by the user. An accumulator is installed at the delivery center, and accumulates data sent by the sending unit. A providing unit, which is also installed at the delivery center, obtains the data designated by the user from the accumulator, records the data in a recording medium, and provides it to the user.

### BACKGROUND OF THE INVENTION

1. Field of the Invention

The present invention relates to a system and a method for providing a user with data designated by the user.

2. Description of the Related Art

Along with progress of communication techniques, there are prevailing data providing systems which sell users data such as music data, movie data, game data, etc. which are recorded on predetermined recording media through a communication network.

Information terminals for selling data to users are placed in convenience stores, and music or video software shops.

A user operates one of such information terminals to access a data center which stores a lot of data for sale and download desired data from the data center. The information terminal records the downloaded data in a predetermined recording medium, and passes it to the user.

However, such data providing systems have a problem that it takes a user a lot of time to receive a recording medium on which desired data has been recorded, after arriving at one of such software shops.

### SUMMARY OF THE INVENTION

Accordingly, it is an object of the present invention to provide a data providing system and a data providing method for enabling a user to receive his/her desired data in a short waiting time.

To achieve the above object, a data providing system according to a first aspect of the present invention comprises:

a storage which stores a plurality of data;

a sending unit which obtains data designated by a user from the storage and sends the obtained data to a delivery center at which the user receives the obtained data; and

a providing unit which is installed at the delivery center and provides the data sent from the sending unit to the user,

wherein the sending unit completes sending all or a part of the data designated by the user, by a date designated by the user.

According to this invention, all or a part of data designated by a user will be ready at the delivery center by a date designated by the user. Thus, the user can receive his/her desired data in a short waiting time.

The data providing system may further comprise a scheduler which plans in accordance with a predetermined condition a schedule for completing sending all or a part of the data designated by the user by the date designated by the user.

The sending unit may send all or a part of the data designated by the user to the delivery center in accordance with the schedule planned by the scheduler.

The providing unit may comprise a recorder which records data in a recording medium and thus provides the data to a user.

The sending unit may complete sending a part of the data designated by the user by the date designated by the user, and send the rest of the data while the recorder records the part of the data in a recording medium.

The data providing system may further comprise an accumulator which is installed at the delivery center and accumulates data sent from the sending unit.

The providing unit may obtain all or a part of the data designated by the user from the accumulator and then provide it to the user.

The data providing system may further comprise a determiner which determines whether or not all or a part of the data designated by the user is accumulated in the accumulator.

The scheduler may plan the schedule in a case where the determiner determines that all or a part of the data designated by the user is not accumulated in the accumulator.

The sending unit may send all of the data designated by the user so that the recorder can complete recording all of the data designated by the user by the date designated by the user.

The data providing system may further comprise a scheduler which plans in accordance with a predetermined condition a schedule for the recorder to complete recording all of the data designated by the user by the date designated by the user.

The sending unit may send all of the data designated by the user in accordance with the schedule planned by the scheduler.

The providing unit may obtain all of the data designated by the user from the accumulator and then provide it to the user.

The data providing system may further comprise a determiner which determines whether or not all of the data designated by the user is accumulated in the accumulator.

The scheduler may plan the schedule in a case where the determiner determines that all of the data designated by the user is not accumulated in the accumulator.

The predetermined condition may include at least one of the date designated by the user, a data amount of the data designated by the user, a traffic amount of a communication line between the sending unit and the delivery center, a capacity of the communication line, and a recording speed of the recorder.

The accumulator may delete data accumulated therein in accordance with a predetermined rule.

The accumulator may set a term in which data accumulated therein remains valid, and in a case where the user does not receive the data before the set validity term expires, delete the data.

A data providing method according to a second aspect of the present invention comprises:

an obtaining step of obtaining data designated by a user from a plurality of data stored in a database;

a sending step of sending the data obtained in the obtaining step to a delivery center at which the user receives the data through a communication line; and

a providing step of providing at the delivery center the data sent in the sending step to the user,

wherein the sending step includes a step of completing sending all or a part of the data designated by the user by a date designated by the user.

### BRIEF DESCRIPTION OF THE DRAWINGS

These objects and other objects and advantages of the present invention will become more apparent upon reading of the following detailed description and the accompanying drawings in which:

FIG. 1 is a diagram showing a structure of a data providing system according to the embodiments of the present invention;

FIG. 2 is a flowchart showing an authentication process performed by a search server constituting the data providing system shown in FIG. 1;

FIG. 3 is a flowchart showing a search process performed by the search server; and

FIG. 4 is a flowchart showing a scheduling process performed by a scheduling server constituting the data providing system shown in FIG. 1.

### DETAILED DESCRIPTION OF THE PREFERRED EMBODIMENTS

### First Embodiment

A data providing system according to a first embodiment of the present invention will now be explained with reference to the drawings.

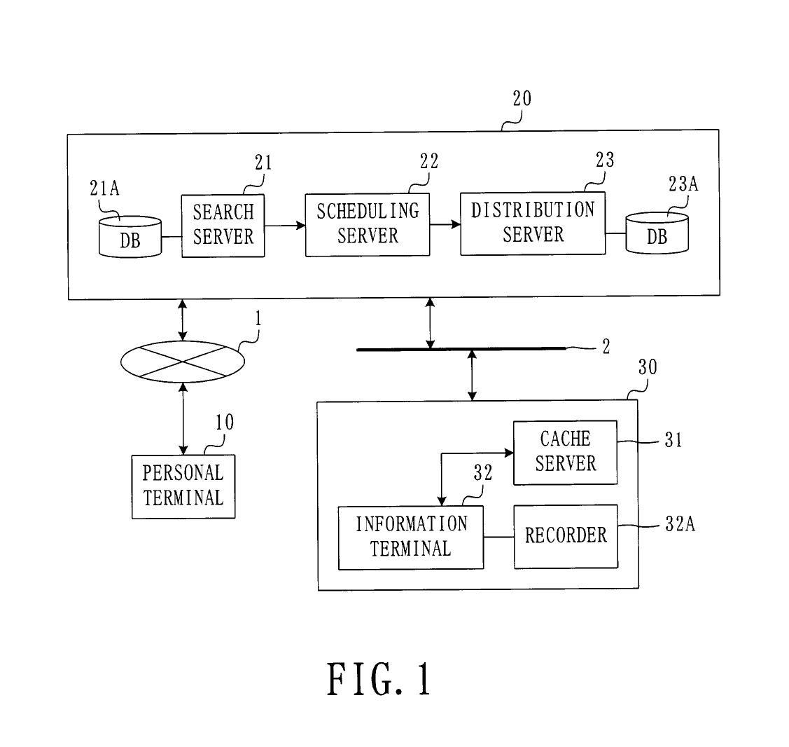

The data providing system according to the first embodiment comprises a personal terminal 10, a data center 20, and a plurality of shops 30, as shown in FIG. 1. Note that in FIG. 1, one of the plurality of shops 30 is shown as a representative example.

The personal terminal 10 is a terminal apparatus comprising a display formed of a liquid crystal panel, and an input device formed of a keyboard or a plurality of input buttons. For example, the personal terminal 10 is a user-owned personal computer, or a user-owned cellular phone having a data communicating function.

The personal terminal 10 is connected to the data center 20 through Internet 1, and sends information necessary for purchasing data (movie software, music software, game software, etc.) to the data center 20 in accordance with an operation of a user. Detailed operations to be performed by the personal terminal 10 will be described later.

The data center 20 stores a lot of data (movie software, music software, game software, etc.) to be sold to users, and is managed by an enterpriser who sells the data.

A search server 21, a scheduling server 22, and a distribution server 23 are installed in the data center 20.

The search server 21 is an ordinary computer constituted by a CPU (Central Processing Unit), a memory, etc., and operates in accordance with a pre-provided program. The search server 21 includes a database (DB) 21A which stores member data and title data.

The member data includes information (membership number, password, name, address, phone number, e-mail address, credit card number, etc.) regarding a user who is registered in the data center 20. The title data represents a title of data for sale stored in the data center 20.

The search server 21 authenticates a user using the member data. The search server 21 searches for data designated by an authenticated user using the title data. Detailed operations performed by the search server 21 will be described later.

The scheduling server 22 is an ordinary computer formed of a CPU, a memory, etc., and operates in accordance with a pre-provided program. For example, the scheduling server 22 determines whether or not data designated by a user is stored in a shop 30 designated by the user. In a case where the designated data is not stored in the designated shop 30, the scheduling server 22 plans a schedule for sending the data designated by the user to the shop 30 designated by the user by a date designated by the user. Detailed operations performed by the scheduling server 22 will be described later.

The distribution server 23 is an ordinary computer formed of a CPU, a memory, etc., and operates in accordance with a pre-provided program. The distribution server 23 includes a database 23A which stores a plurality of data for sale.

The distribution server 23 obtains data designated by a user from the database 23A and sends the data to the shop 30 designated by the user in accordance with a schedule made by the scheduling server 22.

The plurality of shops 30 are located separately from the data center 20, and managed by the enterpriser who sells data. The plurality of shops 30 and the data center 20 are connected to each other through a private line 2 having large capacity, in order to secure predetermined data transmission rates, and block invalid access from outside.

A cache server 31 and an information terminal 32 are placed in each of the plurality of shops 30.

The cache server 31 stores data for sale supplied from the distribution server 23 of the data center 20. The cache server 31 erases data stored therein in a case where its capacity becomes full, in accordance with a pre provided program. For example, the cache server 31 erases older data first, of data which have been already provided to users.

The information terminal 32 is a computer comprising a display constituted by a liquid crystal panel or the like, and an input device constituted by a keyboard or a touch panel, and operates in accordance with a pre-provided program. In addition, the information terminal 32 comprises a recorder 32A for accommodating a recording medium such as a CD-RW (Compact Disk ReWritable), a DVD-R (Digital Versatile Disk Rewritable), and recording data on the accommodated recording medium.

The information terminal 32 obtains data designated by a user from the cache server 31. Then, the information terminal 32 controls the recorder 32A to record the obtained data in a recording medium, and provides it to the user. Detailed operations performed by the information terminal 32 will be described later.

Next, operations of the data providing system according to the first embodiment will be explained.

A user who wishes to use the data providing system performs a predetermined registration procedure. Thus, the user who requests the usage of the data providing system is registered in the data center 20. A membership number and a password are issued from the data center 20 for the registered user. Information regarding the registered user (membership number, password, name, address, phone number, e-mail address, credit card number, etc.) is stored in the database 21A as member data.

A registered user accesses the search server 21 of the data center 20 by operating the personal terminal 10.

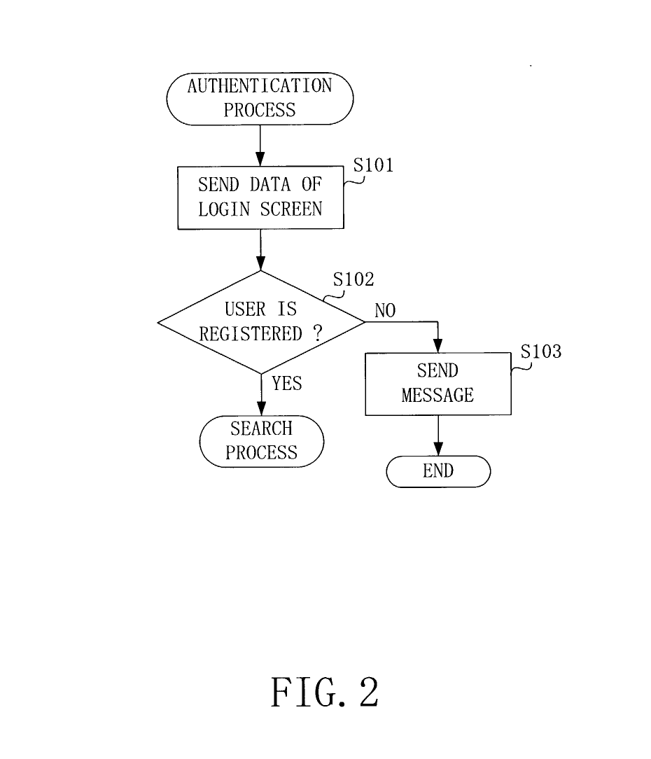

The search server 21 starts an authentication process shown in FIG. 2 in response to the access from the user.

First, the search server 21 sends data representing a login screen for demanding input of identification information (membership number and password) for identifying the user, to the personal terminal 10 (step S101).

The personal terminal 10 displays the login screen on a display using the data supplied from the search server 21. The user operates the personal terminal 10 and inputs his/her membership number and password in the displayed login screen. In response to the operation of the user, the personal terminal 10 sends the input membership number and password to the search server 21.

In response to the membership number and password from the personal terminal 10, the search server 21 determines whether or not the user is registered in the data center 20, using the member data stored in the database 21A (step S102). Specifically, the search server 21 determines whether or not any number and password corresponding to the supplied membership number and password are included in the member data.

In a case where it is determined that corresponding number and password are not included, i.e., it is determined that the user is not registered (step S102; NO), the search server 21 sends a message for inviting the user to register in the data center 20 to the personal terminal 10 (step S103), and ends the authentication process.

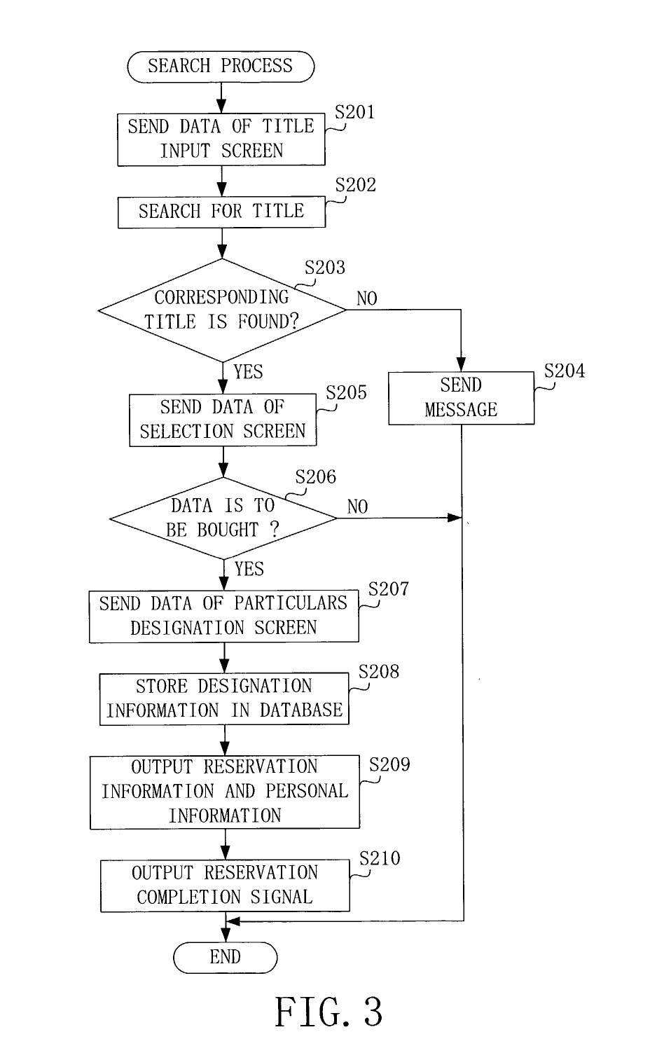

On the contrary, in a case where it is determined that corresponding number and password are included, i.e., it is determined that the user is registered (step S102; YES), the search server 21 starts a search process shown in FIG. 3.

First, the search server 21 sends data representing a title input screen for inputting a title of data to be searched to the personal terminal 10 (step S201).

The personal terminal 10 displays the title input screen on the display using the data supplied from the search server 21. The user operates the personal terminal 10 and inputs the title of the data he/she desires to search in the displayed title input screen. In response to the operation of the user, the personal terminal 10 sends the input title to the search server 21.

In response to the title supplied from the personal terminal 10, the search server 21 searches for the supplied title using the title data stored in the database 21A (step S202).

Then, the search server 21 determines whether or not any title corresponding to the supplied title is included in the title data (step S203). Based on this, the search server 21 determines whether or not the data which is the object to be found is stored in the data center 20.

In a case where it is determined that no corresponding title is included (step S203; NO), the search server 21 determines that the data to be found is not stored in the data center 20. Then, the search server 21 sends a message informing that the subject data is not stored in the data center 20 to the personal terminal 10 (step S204), and ends the search process.

On the contrary, in a case where it is determined that a corresponding title is included (step S203; YES), the search server 21 determines that the subject data is stored in the data center 20. Then, the search server 21 sends data representing a selection screen for selecting whether or not to buy the searched data, to the personal terminal 10 (step S205).

The personal terminal 10 displays the selection screen on its display using the data supplied form the search server 21. The user operates the personal terminal 10, and selects whether or not to buy the searched data on the displayed selection screen. In response to the operation of the user, the personal terminal 10 sends the user's selection result to the search server 21.

In response to the selection result supplied from the personal terminal 10, the search server 21 determines whether or not the user is to buy the searched data (step S206).

In a case where it is determined that the user is not to buy the data (step S206; NO), the search server 2 ends the search process.

On the contrary, in a case where it is determined that the user is to buy the data (step S206; YES), the search server 21 sends data representing particulars designation screen for designating the date and place (shop 30) to receive the searched data, i.e., the data to be bought, and the charge settlement method, to the personal terminal 10 (step S207).

The personal terminal 10 displays the particulars designation screen on its display using the data supplied from the search server 21. The user operates the personal terminal 10, and designates the date, the shop 30, and the settlement method on the displayed particulars designation screen. In response to the user's operation, the personal terminal 10 sends information of the designated date, shop 30, and settlement method to the search server 21.

In response to the information supplied from the personal terminal 10, the search server 21 stores designation information representing the title, date, shop 30, and settlement method designated by the user in the database 21A in association with the member data of the user who has logged in (step S208).

Next, the search server 21 outputs reservation information representing the title, date, and shop 30 designated by the user in association with the user's personal information (name, membership number, etc.) to the scheduling server 22 (step S209).

Then, the search server 21 sends a reservation completion signal representing that the reservation for the data purchase has been accepted to the personal terminal 10 (step S210), and ends the search process.

In response to the reservation completion signal from the search server 21, the personal terminal 10 displays a predetermined message on its display to inform the user that the reservation for the data purchase has been accepted.

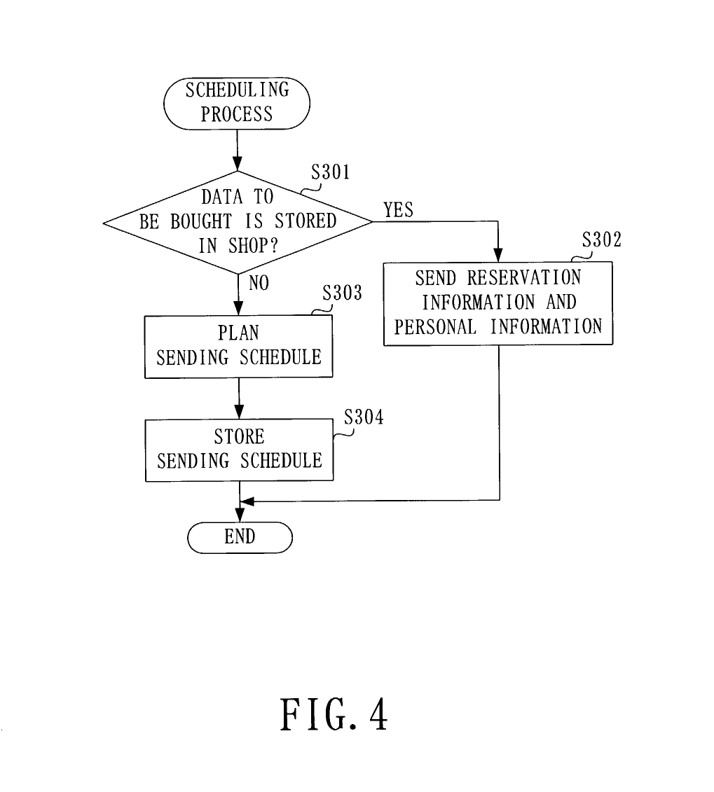

On the other hand, the scheduling server 22 starts a scheduling process shown in FIG. 4 in response to the reservation information and personal information supplied from the search server 21.

First, the scheduling server 22 determines whether or not the user's designated data to be bought is stored in the shop 30 designated by the user (step S301). Specifically, the scheduling server 22 accesses the cache server 31 of the shop 30 indicated by the reservation information, and determines whether or not data having the title indicated by the reservation information is stored.

In a case where it is determined that the data to be bought is stored (step S301; YES), the scheduling server 22 sends the reservation information and personal information supplied thereto, to the information terminal 32 of the shop 30 indicated by the reservation information (step S302), and ends the scheduling process.

The information terminal 32 stores the reservation information and personal information supplied from the scheduling server 22.

On the contrary, in a case where it is determined that the data to be bought is not stored (step S301; NO), the scheduling server 22 plans a sending schedule for sending the user's designated data to be bought to the user's designated shop 30 by the date designated by the user (step S303).

Specifically, the scheduling server 22 obtains data amount of the data having the title indicated by the reservation information from the distribution server 23. Further, the scheduling server 22 obtains the traffic amount of the private line 2 using sending schedules for other data. Then, the scheduling server 22 determines the date to send the data to be bought in accordance with a predetermined method, based on the designated date, the obtained data amount, the obtained traffic amount, and the capacity of the private line 2.

Then, the scheduling server 22 stores the determined sending date as the sending schedule in association with the supplied reservation information and personal information (step S304), and ends the scheduling process.

Afterwards, the scheduling server 22 instructs the distribution server 23 to start sending the data to be bought on the sending date indicated by each stored sending schedule. Specifically, the scheduling server 22 instructs the distribution server 23 to send the data having the title indicated by the reservation information associated with the sending schedule to the shop 30 indicated by the reservation information. In addition, the scheduling server 22 sends the reservation information and personal information associated with the sending schedule to the information terminal 32 of the shop 30 indicated by the reservation information.

The information terminal 32 stores the reservation information and personal information supplied from the scheduling server 22.

The distribution server 23 obtains the data to be bought from the database 23A in response to the instruction from the scheduling server 22, and sends the obtained data to the cache server 31 of the designated shop 30.

The cache server 31 stores the data to be bought which is supplied from the distribution server 23.

In this way, the user's designated data to be bought will arrive at the shop 30 designated by the user by the date designated by the user.

The user goes to the designated shop 30 on the designated date, and receives the designated data.

Specifically, the user operates the information terminal 32 placed in the shop 30 and inputs his/her name and membership number.

The information terminal 32 specifies the reservation information and personal information of this user from its stored information, using the input name and membership number.

Then, the information terminal 32 obtains the data having the title indicated by the specified reservation information from the cache server 31.

The user prepares a recording medium for recording the data to be bought in advance, or purchases one in the shop 30. Then, the user sets the recording medium into the recorder 32A.

When the recording medium is set in the recorder 32A, the information terminal 32 controls the recorder 32A to record the obtained data in the recording medium, and provides the recorded data to the user.

Then, the information terminal 32 sends a provision completion signal representing that the data has been provided, together with the personal information of the user having been provided with the data, to the search server 21.

In response to the provision completion signal supplied from the information terminal 32, the search server 21 specifies the user who has received the data, using the personal information supplied together with the provision completion signal. Then, the search server 21 attaches a completion symbol representing that the data has been provided to the designation information of the specified user.

The charge for the data is calculated on a predetermined date (for example, a predetermined date in every month) in accordance with a predetermined method, using the designation information attached with the completion symbol and the member data associated with this designation information stored in the database 21A. The calculated charge is settled in accordance with the settlement method indicated by the designation information.

In this way, the data designated by the user can be stored in the shop 30 designated by the user by the date designated by the user. Consequently, the user can receive the recording medium in which the designated data is recorded in a short waiting time after showing up in the shop 30.

Further, according to the above data providing system, data which is not planned to be bought, is not stored in the cache server 31. Therefore, the limited capacity of the cache server 31 can be effectively utilized.

### Second Embodiment

Next, a data providing system according to a second embodiment of the present invention will be explained with reference to the drawings.

In the second embodiment, data designated by a user will be recorded in a recording medium in a shop 30 designated by the user by a date designated by the user.

In this case, the recorder 32A is structured such that it can store a plurality of unrecorded recording media in which no data is recorded, and a plurality of recorded recording media in which data has been recorded.

The structure of the data providing system other than the above is substantially the same as that show in the first embodiment.

Operations of the data providing system according to the second embodiment will now be explained.

A user registered in the data center 20 accesses the search server 21 by operating the personal terminal 10 likewise the first embodiment. Thus, an authentication process and a search process same as those in the first embodiment will be performed.

The scheduling server 22 starts the scheduling process shown in FIG. 4 in response to reservation information and personal information supplied from the search server 21.

Note that in step S303, the scheduling server 22 plans a sending schedule for recording the data designated by the user in a recording medium by the date designated by the user in the shop 30 designated by the user.

Specifically, the scheduling server 22 adds a speed of the recorder 32A to record data in a recording medium to the conditions shown in the first embodiment (designated date, data amount, traffic amount of the private line 2, and capacity of the private line 2), and determines the sending date of the data to be bought in accordance with a predetermined method.

Then, in step S304, the scheduling server 22 stores the determined sending date as the sending schedule in association with supplied reservation information and personal information, and ends the scheduling process.

The scheduling server 22 instructs the distribution server 23 to start sending the data to be bought on the sending date indicated by the stored sending schedule, likewise the first embodiment. Also, the scheduling server 22 sends the reservation information and personal information associated with the sending schedule, to the information terminal 32 of the shop 30 indicated by the reservation information.

In response to the instruction from the scheduling server 22, the distribution server 23 obtains the data to be bought from the database 23A, and sends the obtained data to the cache server 31 of the designated shop 30.

The cache server 31 stores the data to be bought which is supplied from the distribution server 23.

The information terminal 32 stores the reservation information and personal information supplied from the scheduling server 22.

Then, the information terminal 32 obtains data having the title indicated by the stored reservation information from the cache server 31, by the date indicated by the reservation information. Then, the information terminal 32 controls the recorder 32A to record the obtained data in an unrecorded recording medium stored in the recorder 32A.

In the way described above, the user's designated data to be bought is recorded in a recording medium by the date designated by the user.

The user goes to the designated shop 30 on the designated date, and receives the designated data.

Specifically, the user operates the information terminal 32 placed in the shop 30, and inputs his/her name and membership number.

The information terminal 32 specifies the reservation information and personal information of this user from the stored information, using the input name and membership number.

Then, the information terminal 32 controls the recorder 32A to pass the recording medium in which the data having the title indicated by the specified reservation information is recorded, to the user.

Afterwards, the information terminal 32 sends a provision completion signal representing that the data has been provided to the search server 21 along with the personal information of the user who has been provided with the data.

Operations thereafter are substantially the same as those in the first embodiment.

In the way described above, the data designated by the user can be recorded in a recording medium in the shop 30 designated by the user by the date designated by the user. Therefore, the waiting time for the user to receive the recording medium after arriving at the shop 30 can be more shortened than in the case of the first embodiment.

### Third Embodiment

Next, a data providing system according to a third embodiment will be explained with reference to the drawings.

The structure of the data providing system according to the third embodiment is substantially the same as that of the first embodiment.

In the third embodiment, a part of data designated by a user (for example, one third of the data from the head) will be stored in a shop 30 designated by the user by the date designated by the user. Then, the rest of the data will be sent to the shop 30 designated by the user while the recorder 32A records the head part of the data in a recording medium.

In this case, the scheduling server 22 performs the scheduling process shown in FIG. 4 for a part of the data.

Specifically, in step S301, the scheduling server 22 determines whether or not a part of the data to be bought is stored in the shop 30 designated by the user.

In a case where it is determined that a part is stored (step S301; YES), the scheduling server 22 sends the reservation information and personal information to the information terminal 32 of the designated shop 30 (step S302).

On the contrary, in a case where it is determined that a part is not stored (step S301; NO), the scheduling server 22 plans a sending schedule for sending a part of the data to be bought to the shop 30 designated by the user by the date designated by the user (step S303).

Then, in step S304, the scheduling server 22 stores the sending schedule in association with the reservation information and personal information, and ends the scheduling process.

The scheduling server 22 instructs the distribution server 23 to start sending a part of the data to be bought on the date indicated by the stored sending schedule.

In response to the instruction from the scheduling server 22, the distribution server 23 obtains a part of the data to be bought from the database 23A, and sends the part to the cache server 31 of the designated shop 30.

Due to this, a part of the user's designated data to be bought will be prepared in the shop 30 designated by the user by the date designated by the user.

The user goes to the designated shop 30 on the designated date, and operates the information terminal 32 and inputs his/her name and membership number.

Likewise the first embodiment, the information terminal 32 specifies the reservation information and personal information of this user from the stored information, using the input name and membership number.

Then, the information terminal 32 requests the distribution server 23 to supply the remaining part of the data having the title indicated by the specified reservation information.

Then, the information terminal 32 obtains the part of the data having the title indicated by the specified reservation information from the cache server 31. Then, the information terminal 32 controls the recorder 32A to record the obtained part of the data in a recording medium.

On the other hand, at the request of the information terminal 32, the distribution server 23 obtains the remaining part of the data which is requested, from the database 23A, and sends it to the information terminal 32. Due to this, the remaining part of the data is supplied from the distribution server 23 to the information terminal 32 while the preceding part of the data is being recorded in a recording medium.

The information terminal 32 controls the recorder 32A to record the supplied remaining part of the data in the recording medium successively to the preceding part.

Operations other than the above are substantially the same as those in the first embodiment.

By carrying out the recording of one part of data and the supply of the remaining part of the data in parallel as described above, a larger number of data than in the case of the first embodiment can be stored in the cache server 31.

Further, a part of data has already been stored in the shop 30 by the date designated by the user. Accordingly, the waiting time for the user to receive the recorded recording medium after arriving at the shop 30 is substantially the same as that in the case of the first embodiment.

The data center 20 and the plurality of shops 30 may be connected by the Internet 1, not by the private line 2.

Further, the scheduling server 22 may plan a sending schedule using at least one of the aforementioned conditions (designated date, data amount, traffic amount of the private line 2, capacity of the private line 2, and recording speed).

The cache server 31 may delete data designated by a user, if the user does not show up in the designated shop 30 on and after the designated date.

The personal information stored in the information terminal 32 may include information on user's reliability evaluated based on the user's usage records and the user's rate of sureness to come to receive the data. In a case where the user does not appear in the designated shop 30 on the designated date, the cache server 31 may obtain this user's personal information from the information terminal 32 to set the term for the validity of the data in accordance with a predetermined method, based on the user's usage records and reliability. Then, in a case where the user does not even appear in the designated shop 30 before the term for the validity of the data expires, the cache server 31 may delete the data.

It is possible that the recording medium with data recorded is not sold, but only rented.

In FIG. 1, there are shown the information terminal 32 and the recorder 32A separately. However, the recorder 32A may be incorporated in the information terminal 32.

Further, data to be provided to a user may not be recorded in a recording medium. For example, the personal terminal 10 may be connected to the information terminal 32 through a specially-built cable, etc. Then, the information terminal 32 may directly supply the data obtained from the cache server 31 to the personal terminal 10 connected thereto.

The apparatus of the present invention can be realized by a general computer, without the need for a dedicated apparatus. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the apparatus of the present invention. The above program and data may be stored in a disk device or the like included in the server device on the Internet, and embedded in a carrier wave. The program and data embedded in the carrier wave may be downloaded into a carrier wave. The program and data embedded in the carrier wave may be downloaded into the computer so as to realize the apparatus of the present invention.

Various embodiments and changes may be made there unto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2001-307063 filed on Oct. 3, 2001 and including specification, claims, drawings and summary. The disclosure of the above Japanese Patent Application is incorporated herein by reference in its entirety.

What is claimed is:

1. A data providing system comprising:
a storage which stores a plurality of data;
a sending unit which obtains data designated by a user from said storage and sends the obtained data to a delivery center at which the user receives the obtained data; and
a providing unit which is installed at said delivery center and provides the data sent from said sending unit to the user,
wherein said sending unit completes sending all or a part of the data designated by the user, by a date designated by the user.

2. The data providing system according to claim 1, further comprising a scheduler which plans in accordance with a predetermined condition a schedule for completing sending all or a part of the data designated by the user by the date designated by the user,
wherein said sending unit sends all or a part of the data designated by the user to said delivery center in accordance with the schedule planned by said scheduler.

3. The data providing system according to claim 2, wherein:
said providing unit comprises a recorder which records data in a recording medium and thus provides the data to a user; and
said sending unit completes sending a part of the data designated by the user by the date designated by the user, and sends the rest of the data while said recorder records the part of the data in a recording medium.

4. The data providing system according to claim 2, further comprising an accumulator which is installed at said delivery center and accumulates data sent from said sending unit,
wherein said providing unit obtains all or a part of the data designated by the user from said accumulator and then provides it to the user.

5. The data providing system according to claim 4, further comprising a determiner which determines whether or not all or a part of the data designated by the user is accumulated in said accumulator,
wherein said scheduler plans the schedule in a case where said determiner determines that all or a part of the data designated by the user is not accumulated in said accumulator.

6. The data providing system according to claim 2, wherein the predetermined condition includes at least one of the date designated by the user, a data amount of the data designated by the user, a traffic amount of a communication line between said sending unit and said delivery center, and a capacity of said communication line.

7. The data providing system according to claim 4, wherein said accumulator deletes data accumulated therein in accordance with a predetermined rule.

8. The data providing system according to claim 7, wherein said accumulator sets a term in which data accumulated therein remains valid, and in a case where the user does not receive the data before the set validity term expires, deletes the data.

9. The data providing system according to claim 1, wherein:
said providing unit comprises a recorder which records data in a recording medium and thus provides the data to a user; and
said sending unit sends all of the data designated by the user so that said recorder can complete recording all of the data designated by the user by the date designated by the user.

10. The data providing system according to claim 9, further comprising a scheduler which plans in accordance with a predetermined condition a schedule for said recorder to complete recording all of the data designated by the user by the date designated by the user,
wherein said sending unit sends all of the data designated by the user in accordance with the schedule planned by said scheduler.

11. The data providing system according to claim 10, further comprising an accumulator which is installed at said delivery center, and accumulates data sent from said sending unit,
wherein said providing unit obtains all of the data designated by the user from said accumulator and then provides it to the user.

12. The data providing system according to claim 11, further comprising a determiner which determines whether or not all of the data designated by the user is accumulated in said accumulator,
wherein said scheduler plans the schedule in a case where said determiner determines that all of the data designated by the user is not accumulated in said accumulator.

13. The data providing system according to claim 10, wherein the predetermined condition includes at least one of the date designated by the user, a data amount of the data designated by the user, a traffic amount of a communication line between said sending unit and said delivery center, a capacity of said communication line, and a recording speed of said recorder.

14. The data providing system according to claim 11, wherein said accumulator deletes data accumulated therein in accordance with a predetermined rule.

15. The data providing system according to claim 14, wherein said accumulator sets a term in which data accumulated therein remains valid, and in a case wherein the user does not receive the data before the set validity term expires, deletes the data.

16. A data providing method comprising:
an obtaining step of obtaining data designated by a user from a plurality of data stored in a database;
a sending step of sending the data obtained in said obtaining step to a delivery center at which the user receives the data through a communication line; and
a providing step of providing at said delivery center the data sent in said sending step to the user,
wherein said sending step includes a step of completing sending all or a part of the data designated by the user by a date designated by the user.
